(19) United States
(12) Patent Application Publication
(10) Pub. No.: US 2010/0001121 A1
(43) Pub. Date: Jan. 7, 2010

(54) SYSTEM FOR TILTING A POWER UNIT

(75) Inventors: Jorge Pablo VERDE PRECKLER, Madrid (ES); Jose Miguel VIZARRO TORIBIO, Madrid (ES); Raul Carlos LLAMAS SANDIN, Madrid (ES)

Correspondence Address: LADAS & PARRY LLP, 26 WEST 61ST STREET, NEW YORK, NY, 10023, US

(73) Assignee: AIRBUS ESPANA, S.L..

(21) Appl. No.: 12/182,568

(22) Filed: Jul. 30, 2008

(30) Foreign Application Priority Data
May 30, 2008 (ES) 200801624

(51) Int. Cl. B64D 27/00

(52) U.S. Cl. 244/12.5

(57) ABSTRACT

System for tilting a power unit (4) of an aircraft, said power unit (4) being located in the rear portion of the fuselage (1) of the aircraft, said system comprising a tilting unit (21) and a pivoting unit (6), with said tilting unit (21) permitting the tilting of the power unit (4) in a plane parallel to the vertical plane of the aircraft via the pivoting unit (6), giving rise to deflection of the exhaust gases from power unit (4), thus providing a vectorial thrust controllable independently for each power unit (4) of the aircraft, optimum for each phase of flight or manoeuvre of said aircraft, said component of vector thrust being deflected angularly in a plane parallel to the vertical plane of the aircraft and relative to the longitudinal axis of said aircraft.

### FIELD OF THE INVENTION

The present invention relates to a system for tilting a power unit, in particular of aircraft, and more particularly a power unit located on the rear fuselage of the aircraft.

### BACKGROUND OF THE INVENTION

The beneficial effects resulting from the use of aircraft engines that generate vectorial or controllable-direction thrust have been investigated extensively and are well known. As described in document U.S. Pat. No. 6,938,408 B2, the effectiveness of these systems was initially demonstrated in military aviation for flight at low velocity, as well as for flying conditions at high angles of attack. Their initial application in this type of aircraft can also be understood from analysis of the nature of the latter, i.e. from the aircraft design concept where manoeuvrability takes precedence over stability. In civil aviation, the positive influence of the generation of vectorial or controllable-direction thrust relates to flight at medium-high velocity and at high altitude principally in the cruising phase, as well as in other flying conditions, for example take-off. The vectorial thrust system, in a similar manner to the functioning of the aerodynamic and control surfaces, can contribute to deviation of the aircraft from its point of equilibrium or vice versa, so that the aircraft becomes more stable, and accordingly it is then applicable to civil aviation. Applying the generation of vectorial or controllable-direction thrust of aircraft engines located in the tail unit (on the rear fuselage) of said aircraft also contributes to the aircraft being more stable with respect to directional static stability and therefore, when the aircraft is subjected, once stabilized, to a crosswind, it reacts by turning and facing the new wind direction.

Systems are known in aircraft for civil use with configuration of engines positioned on the rear fuselage, that make use of the positive effects of being able to control the direction of the exhaust gases of said aircraft engines. Document ES 2010586, for example, describes the development of a system that makes it possible to control the thrust vector of the engines by acting on the selective deviation of the exhaust gases of the engine and/or of the air of the bypass fan by means of directionally variable mechanical elements within the nozzle. Such a system adds considerable complexity, as it includes moving parts in the nozzles and in the control systems. Systems of this type are not feasible in aircraft for civil use owing to their low reliability and to the high maintenance costs required. Moreover, they do not provide precise manoeuvrability or control of the aircraft.

The present invention aims to solve the shortcomings outlined above.

### SUMMARY OF THE INVENTION

Thus, the aim of this invention is to develop a system to provide rocking or tilting of the power unit of aircraft, in particular of large aircraft for civil use and, more particularly, of aircraft that incorporate a configuration of power units positioned on the rear fuselage of the aircraft, above or below the pylons thereof, enabling the aircraft to be optimized in various flying conditions, principally at take-off and while cruising.

Owing to the fact that the effect of the system of the invention will be appreciable, the invention relates to a system for aircraft with configurations of power units located in the rear portion of the fuselage, and more concretely aircraft whose power units are located above or below the pylons. In this way, the deflecting power of the thrust of the power units will contribute to a greater extent to ensuring that the requirements of lift of the tailplane are less than in configurations with power units located in the wing structure, thus making it possible to reduce the surface area of said tailplane and, in consequence, the weight of the assembly and the fuel consumption. In a configuration as described previously, and derived from the air inlet to the power units behind the centre of gravity thereof, the aircraft will be more stable with respect to directional static stability, so that its capacity for recovery of position will be greater for flying conditions with a crosswind.

The system of the invention therefore relates to an aircraft configuration as just described, said system controlling the vectoriality of the exhaust gases of the power units of said aircraft. One of the advantages of the invention is the positive influence that it produces in the various flying conditions, in providing additional control for generating a pitching moment in the aircraft, especially at take-off and when cruising, though also in the phases of climb, descent and landing. This means that the propulsive requirements of the power units are lower for some established flying conditions or that, at equal propulsion of said power units, the flying conditions can be optimized.

Another important advantage of the system of the invention is that it uses conventional power units, in particular engines, which require no modification, simplifying its application and making its use more feasible. This system also introduces an improvement relative to other systems of the prior art, in that it does not alter the function of other parts of the aircraft, thus minimizing the noise and the aerodynamic drag that would result from the deflection of the modified parts, as is the case with the known solutions.

Another of the added advantages of the system of the invention derives from the elimination of an added structure that permits movement of the assembly as a rigid solid: the system developed by the present invention has independent systems for tilting the power units, which means that, as well as contributing to an improvement in the various flying conditions of the aircraft, it provides a system for additional control of manoeuvrability of said aircraft, since control of the asymmetric deflection of the discharge of gases from the power units, and therefore of the thrust, will result in additional support for the turning manoeuvre of the aircraft.

Thus, the present invention relates to the development of a system for tilting power units of aircraft, said power units being located above the profile tip zone of the pylons or under said zone, so that it becomes possible to induce on said power units a movement that provides controllability, vectoriality and optimization of thrust for each flight phase of the aircraft, as well as an additional contribution to the turning manoeuvre in the yaw movement of said aircraft, without having recourse to modification of the functionality of the pylons or of the internal structure of conventional power units, in particular conventional engines, with single, horizontal discharge of gases.

Thus, owing to the contribution to the stability of the aircraft that is provided by the vectoriality of the exhaust gases from the power units, in a similar manner to the tailplane, an improvement in energy efficiency of the aircraft is achieved owing to reduction of the area of the tail unit and to the fact that the aircraft, operating with smaller angles of attack, create less aerodynamic drag. A positive thrust angle of the power units means that the requirements on lift of the aircraft wing are reduced and that for each flight mode there is an optimum thrust angle: thus, by controlling this thrust angle of the power units by means of the vectoriality of the exhaust gases it will be possible to reduce the take-off velocity and distance, reach higher altitudes without increasing the propulsion during climb, and moreover achieve minimum cruising propulsion, a better gliding range during descent, as well as reducing the aircraft's runway approach velocity and its landing distance. These are advantages achieved by means of the system of the present invention.

Thus, the system of the invention, in contrast to the known systems, contributes to control of aircraft manoeuvrability by providing a system for tilting the power units with independent operation. Accordingly, according to the invention, since the system for tilting the power units is regulated by the control systems of the aircraft, turning of the aircraft can be assisted by asymmetric deflection of the exhaust gases, i.e. by inducing a positive angle in one of the two propulsion systems and a negative angle in the other, and vice versa. Obviously, in absolute terms, this effect will be less than in configurations of power units mounted above the fuselage or the wings, but is not negligible. The fact that movement of the power units does not involve movement of the pylons will result in the air flow deflected by the aerofoil impinging in an optimum manner on the surface of the pylons downstream, therefore reducing the aerodynamic drag that would result from a change in inclination of the pylons and, to a marked extent, the noise that this would produce.

Other characteristics and advantages of the present invention will become clear from the following detailed description of a typical embodiment, referring to the accompanying drawings.

### DESCRIPTION OF THE DRAWINGS

FIG. 1 shows, schematically and in profile, an aircraft that includes a system for tilting the power units according to a first embodiment of the present invention.

FIG. 2 shows, schematically, a detail of FIG. 1 around the zone where the pylon is located and the pivoting zone of an aircraft that has a system for tilting the power units according to a first embodiment of the present invention.

FIG. 3 shows, schematically and in plan, an aircraft that has a system for tilting the power units according to a first embodiment of the present invention.

FIG. 4 shows, schematically and in profile, an aircraft that has a system for tilting the power units according to a second embodiment of the present invention.

FIG. 5 shows, schematically, a detail of FIG. 4 around the zone where the pylon is located and the pivoting zone of an aircraft that has a system for tilting the power units according to a second embodiment of the present invention.

### DETAILED DESCRIPTION OF THE INVENTION

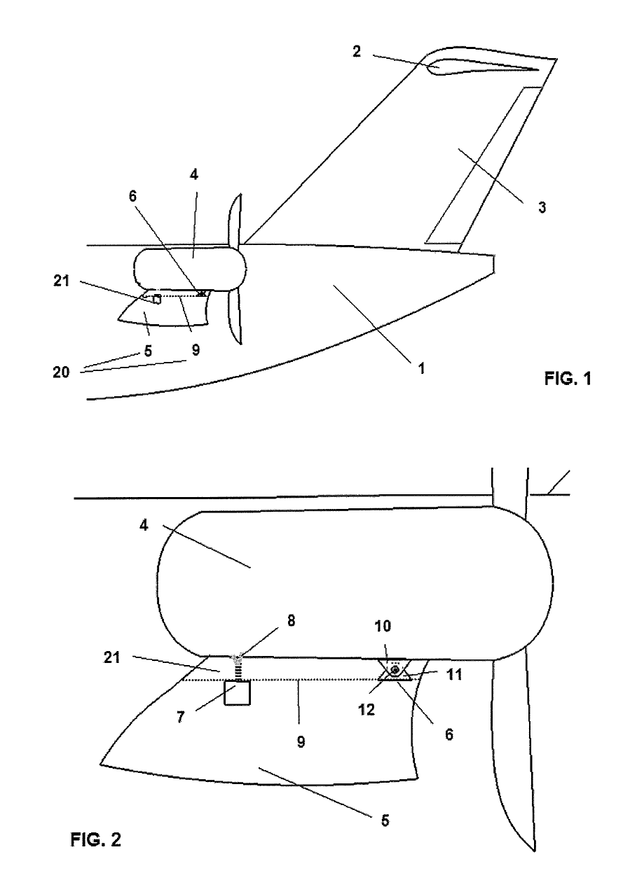

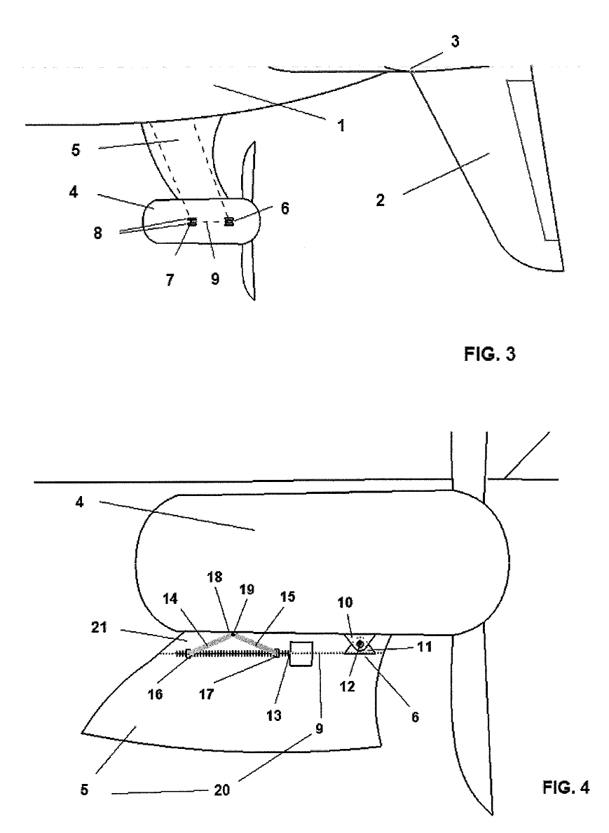

As can be seen in FIGS. 1 and 3, which correspond to the representation in profile and in plan of an aircraft that has a system for tilting the power units according to a first embodiment of the invention, for configurations of aircraft with power units 4 located in the rear portion of the fuselage 1, the aim of the invention is to provide a system that makes it possible to vary the thrust vector of said power units 4. Varying the direction of discharge of gases from the power units 4 provides suitable additional control in the various flying conditions of the aircraft, so that pitching moments can be induced in the aircraft, by symmetrical deflection of the exhaust gases of the power units, or yawing and twisting moments in the aircraft, by means of asymmetric deflections of the exhaust gases of the power units.

Thus, the system for tilting the power units 4 of the present invention comprises a tilting unit 21 and a pivoting unit 6. The tilting unit 21 permits tilting of the power units 4 via the pivoting unit 6, by deflection of the exhaust gases of said power units 4. These power units 4 are supported on the aircraft by means of a supporting unit 20, which comprises pylons 5 and spars 9.

According to a first embodiment of the invention, the tilting unit 21 of the system comprises an actuator 7 and a fitting 8 that serves as a link between the actuator 7 and the power unit 4. In its turn, the pivoting unit 6 comprises a fitting 10 that is fixed to power unit 4, a fitting 11 that is fixed to spar 9 of supporting unit 20 and a pivoting spindle 12.

FIG. 1 shows, schematically and in profile, an aircraft that has a system for tilting power unit 4 according to a first embodiment of the invention. The aircraft comprises a tailplane 2, a tail fin 3 and power units 4 positioned above the structure of the pylons 5 of the supporting unit 20. Said power units 4 can also, as mentioned previously, be positioned under the structure of the pylons 5 of the supporting unit 20.

The tilting unit 21 comprises an actuator 7 and a fitting 8. The actuator 7 will preferably be an endless screw, although it can also be an actuator of the hydraulic type. Fitting 8 serves for connecting the tilting unit 21 to the power unit 4. The tilting unit 21 permits tilting of the power units 4 via the pivoting unit 6. Both the actuator 7 of the tilting unit 21, and the pivoting unit 6, are anchored above the supporting structure 20 of the power unit, preferably above the spar 9 of the pylon 5 of said supporting structure 20.

FIG. 2 shows, schematically, a detail of FIG. 1 around the zone of coupling of power unit 4 to pylon 5 of the supporting unit 20 according to a first embodiment of the invention. This diagram shows in greater detail that the pivoting unit 6 comprises a fitting 10 for coupling to power unit 4 and a fitting 11 for coupling to spar 9. The joining of fittings 10 and 11 together gives rise to the pivoting spindle 12 of the pivoting unit 6. This also provides a better view of actuator 7 of the tilting unit 21, as well as its connection to power unit 4 via fitting 8. Balancing or trimming of the power unit 4 will then be achieved by acting on actuator 7, this being an endless screw or a hydraulic device, thus providing suitable vectoriality in the thrust. The movement that is induced in the power unit 4 of the aircraft in its forwardmost side as a consequence of the action of actuator 7 is absorbed by the rearmost side of said power unit 4 owing to the degree of freedom provided by the pivoting spindle 12. FIG. 2 shows the special case of a power unit 4 with a rear propeller, such that these power units 4 have their centre of gravity situated in their rearmost zone, close to the propeller. Accordingly, in the accompanying FIGS. 1-5, the pivoting unit 6 is in consequence located in a zone close to the vertical of the centre of gravity of the power units 4 and therefore balancing or trimming of said power units 4 requires less force. For power units 4 with other configurations different from that shown, we would endeavour to position the pivoting unit 6 in a zone as close as possible to the vertical with the centre of gravity, in such a way that the force required in balancing or trimming would be as small as possible.

FIG. 3 shows, schematically and in plan, with axis of symmetry, an aircraft with a configuration of engines optimized according to the present invention that comprises a tailplane 2, a tail fin 3 and engines 4 located above the pylon 5 and in the rear portion of fuselage 1. It also shows the pivoting spindle 6 and the assembly of actuator 7 and fitting 8 for coupling to the power unit, as well as the spar 9 of the pylon 5 that represents the structure above which engine 4 will be anchored.

With the description of the first two figures and the representation in plan of FIG. 3 it can be seen that the positioning of the mechanism for tilting the engines above the spar 9 in a plane parallel to the vertical of the aircraft ensures that the thrust component is deflected angularly within said plane and relative to the longitudinal axis of the aircraft. The tilting of the engines 4 in the vertical plane is also based on the pivoting zone 6, which is formed by the fittings 10 and 11 that are connected solidly to power unit 4 and to spar 9 respectively and whose coupling gives rise to the pivoting spindle 12 orthogonal to the longitudinal axis of the aircraft and in a plane parallel to the horizontal, and the actuator 7, which will perform a movement preferably in the plane parallel to the vertical where the thrust vector is located or in a plane parallel thereto. A noteworthy characteristic of this process is that we shall not at any point have interfered with the internal structure of conventional engines of aircraft for civil use currently on the market, achieving better energy efficiency, greater stability of the aircraft and improvement in the various flight conditions and manoeuvres.

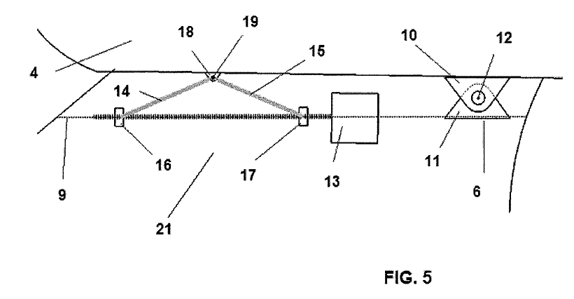

FIG. 4 shows, schematically, the zone for coupling the power unit 4 to the pylon 5 of the supporting structure 20 of an aircraft that has a system for tilting the power units 4 according to a second embodiment of the present invention. As pointed out previously, the use of diagrams in which the power unit 4 is located above the pylon 5 does not exclude configurations for power units 4 located or anchored below the structure of the pylon 5. Thus, the system shown in FIGS. 4 and 5 according to a second embodiment of the invention is preferably used for the type of configuration of power unit 4 under the pylon 5 of the supporting unit 20, although this second embodiment can also be used in configurations such as that shown in FIG. 1, in which the power unit 4 is located above the pylon 5 of the supporting unit 20. The same can apply to FIGS. 1, 2 and 3, it being possible to employ the first embodiment of the invention for configurations of power unit 4 located under the pylon 5 of the supporting unit 20.

Thus, in FIG. 4 we can see that, according to a second embodiment, the tilting system of the invention also comprises a pivoting unit 6 and a tilting unit 21. The tilting unit 21 permits, by means of different components and by a different mechanism, movements identical to tilting unit 21 of the first embodiment. The tilting unit 21 comprises an actuator 13, preferably of the endless screw or hydraulic type, located on the spar 9 of supporting unit 20, connected to power unit 4 via rods 14 and 15, connected movably to one end of actuator 13 via movable fittings 16 and 17, and connected solidly to power unit 4 via a fitting 18. The connecting fitting 18 fixed to power unit 4 will permit angularity in the movement of rods 14 and 15 via the swivel pin 19 in an identical manner and in the same plane of movement as the movable fittings 16 and 17 above actuator 13. The tilting unit 21 is supported, just as in FIG. 1, above the spar 9 of pylon 5, i.e. above the supporting structure 20. Balancing or trimming of the power unit 4 according to the present invention will be executed by acting on the actuator 13, which will produce a movement in rods 14, 15 so that the forwardmost zone of the power unit 4 is raised or lowered (FIG. 4) permitting the movement to be absorbed by the rearward zone of the power unit 4 via the pivoting structure 6, thus providing the appropriate vectoriality in the thrust on the aircraft. To perform the upward or downward movement via rods 14 and 15, either the endless screw 13 will change the thread direction in its intermediate zone, fittings 16 and 17 having the same thread, or the endless screw 13 will have a uniform thread direction on its entire length and the movable fittings 16 and 17 will have opposite threads.

FIG. 5 shows, schematically, a detail of FIG. 4 around the zone where the actuation on power unit 4 takes place, for an aircraft with a tilting system according to a second embodiment of the invention. FIG. 5 shows in greater detail that the system of the invention comprises on the one hand a pivoting unit 6 that comprises in its turn fittings 10 and 11 and a pivoting spindle 12, as well as a tilting unit 21 that comprises in its turn an actuator 13, rods 14 and 15 with their coupling to said actuator 13 via the movable fittings 16 and 17 and to power unit 4 via fitting 18, which, being fixed to power unit 4, will permit movement of rods 14 and 15 about the swivel pin 19. The movement induced by this system on power unit 4 will be identical to that provided by the system described in FIGS. 1, 2 and 3, and will therefore comply with the specifications with respect to planes of movement described previously for said figures (first embodiment of the invention).

The embodiments that we have just described can include modifications that are within the scope defined by the following claims.

1. System for tilting the power unit (4) of an aircraft, said power unit (4) being located in the rear portion of the fuselage (1) of the aircraft, characterized in that it comprises a tilting unit (21) and a pivoting unit (6), said tilting unit (21) permitting the tilting of power unit (4) in a plane parallel to the vertical plane of the aircraft via the pivoting unit (6) giving rise to deflection of the exhaust gases from power unit (4), thus providing vectorial thrust controllable independently for each power unit (4) of the aircraft, optimum for each phase of flight or manoeuvre of said aircraft, said component of vectorial thrust being deflected angularly in a plane parallel to the vertical plane of the aircraft and relative to the longitudinal axis of said aircraft.

2. System for tilting the power unit (4) of an aircraft according to claim 1, characterized in that the pivoting unit (6) is located in a zone as close as possible to the vertical of the centre of gravity of the power unit (4), in such a way that the force required for balancing or trimming of the power unit (4) is the minimum possible.

3. System for tilting the power unit (4) of an aircraft according to claim 1, characterized in that the tilting unit (21) comprises an actuator (7), acting on which performs balancing or trimming of the power unit (4), thus providing the appropriate vectoriality in the thrust, and a fitting (8) that serves as a connection between the actuator (7) and the power unit (4).

4. System for tilting the power unit (4) of an aircraft according to claim 1, characterized in that the tilting unit (21) comprises an actuator (13), connected to the power unit (4) via rods (14, 15), coupled movably to said actuator (13) and coupled in a solid manner to power unit (4), providing balancing or trimming of the power unit (4) on acting upon the actuator (13), which produces a movement in the rods (14, 15) so that the forwardmost zone of the power unit (4) is raised or lowered, thus enabling, via the pivoting unit (6), the rearward zone of the power unit (4) to absorb the movement, in such a way that appropriate vectoriality is provided in the thrust on the aircraft.

5. System for tilting the power unit (4) of an aircraft according to claim 3, characterized in that the actuator (7) and the actuator (13) are endless screws.

6. System for tilting the power unit (4) of an aircraft according to claim 3, characterized in that the actuator (7) and the actuator (13) are hydraulic actuators.

7. System for tilting the power unit (4) of an aircraft according to claim 1, characterized in that the pivoting unit (6) comprises a fitting (10) fixed to the power unit (4), a fitting (11) fixed to the assembly that supports the power unit (4), with the connecting together of the fittings (10, 11) giving rise to a pivoting spindle (12) orthogonal to the longitudinal axis of the aircraft and in a plane parallel to the horizontal.

8. System for tilting the power unit (4) of an aircraft according to claim 1, characterized in that the power unit (4) is supported on the aircraft by means of a supporting unit (20), which comprises pylons (5) and spars (9).

9. System for tilting the power unit (4) of an aircraft according to claim 8, characterized in that the power unit (4) is located above the structure of the pylons (5) of the supporting unit (20).

10. System for tilting the power unit (4) of an aircraft according to claim 8, characterized in that the power unit (4) is located under the structure of the pylons (5) of the supporting unit (20).
